(19) United States
(12) Patent Application Publication
(10) Pub. No.: US 2010/0208398 A1
(43) Pub. Date: Aug. 19, 2010

(54) ELECTROSTATIC DISCHARGE PROTECTION CIRCUIT AND INTEFRATED CIRCUIT UTILIZING THE SAME

(75) Inventor: Yeh-Ning Jou, Taipei County (TW)

Correspondence Address: QUINTERO LAW OFFICE, PC, 615 Hampton Dr, Suite A202, Venice, CA, 90291, US

(73) Assignee: VANGUARD INTERNATIONAL SEMICONDUCTOR CORPORATION, Hsinchu (TW)

(21) Appl. No.: 12/371,092

(22) Filed: Feb. 13, 2009

(51) Int. Cl. H02H 9/04

(52) U.S. Cl. 361/56

(57) ABSTRACT

An ESD protection circuit coupled between a first power line and a second power line to avoid damage to an integrated circuit by an ESD event is disclosed. The ESD protection circuit includes a detection unit, a trigger unit, and a discharging unit. The detection unit asserts a detection signal when the ESD event occurs. The trigger unit asserts a first trigger signal and a second trigger signal when the detection is asserted. The discharging unit provides a discharge path to release an ESD current caused by the ESD event when the first and the second trigger signals are asserted.

### BACKGROUND OF THE INVENTION

1. Field of the Invention

The invention relates to an integrated circuit, and more particularly to an integrated circuit comprising an electrostatic discharge (ESD) protection circuit.

2. Description of the Related Art

As the semiconductor manufacturing process develops, ESD protection has become one of the most critical reliability issues for integrated circuits (IC). In particular, as the semiconductor process advances toward the deep sub-micron stage, scaled-down devices and thinner gate oxides have become more vulnerable to ESD stress.

To protect integrated circuits, a conventional method disposes an ESD protection device in the integrated circuit to release ESD current. FIG. 1 shows a characteristic curve of an ESD protection device. Assuming that an ESD protection device and a core circuit of an integrated circuit are coupled between a first power line and a second power line, when the ESD voltage caused by an ESD event exceeds the trigger voltage V_{trig} of the ESD protection device, the ESD protection device is turned on to release the ESD current. Then, the ESD protection device clamps the voltage difference between the first and the second power lines. Referring to FIG. 1, the voltage difference is maintained in the hold voltage Vₕ.

### BRIEF SUMMARY OF THE INVENTION

ESD protection circuits are provided. An exemplary embodiment of an ESD protection circuit, which is coupled between a first power line and a second power line to avoid damage to an integrated circuit by an ESD event, comprises a detection unit, a trigger unit, and a discharging unit. The detection unit asserts a detection signal when the ESD event occurs. The trigger unit asserts a first trigger signal and a second trigger signal when the detection is asserted. The discharging unit provides a discharge path to release an ESD current caused by the ESD event when the first and the second trigger signals are asserted.

Integrated circuits are also provided. An exemplary embodiment of an integrated circuit comprises a core circuit and an ESD protection circuit. The core circuit is coupled between a first power line and a second power line. The ESD protection circuit is coupled between a first power line and a second power line to avoid damage to the core circuit by an ESD event. The ESD protection circuit comprises a detection unit, a trigger unit, and a discharging unit. The detection unit asserts a detection signal when the ESD event occurs. The trigger unit asserts a first trigger signal and a second trigger signal when the detection is asserted. The discharging unit provides a discharge path to release an ESD current caused by the ESD event when the first and the second trigger signals are asserted.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 shows a characteristic curve of an ESD protection device;

FIG. 2 is a schematic diagram of an exemplary embodiment of an integrated circuit;

FIG. 3 is a schematic diagram of an exemplary embodiment of the ESD protection circuit; and

FIGS. 4˜8 are schematic diagrams of other exemplary embodiments of the ESD protection circuit.

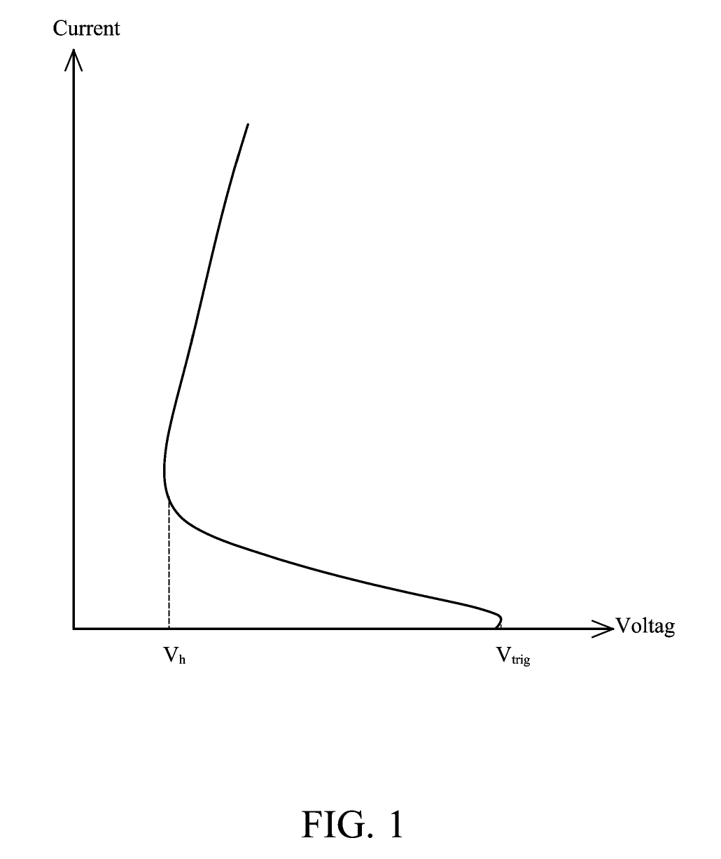

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

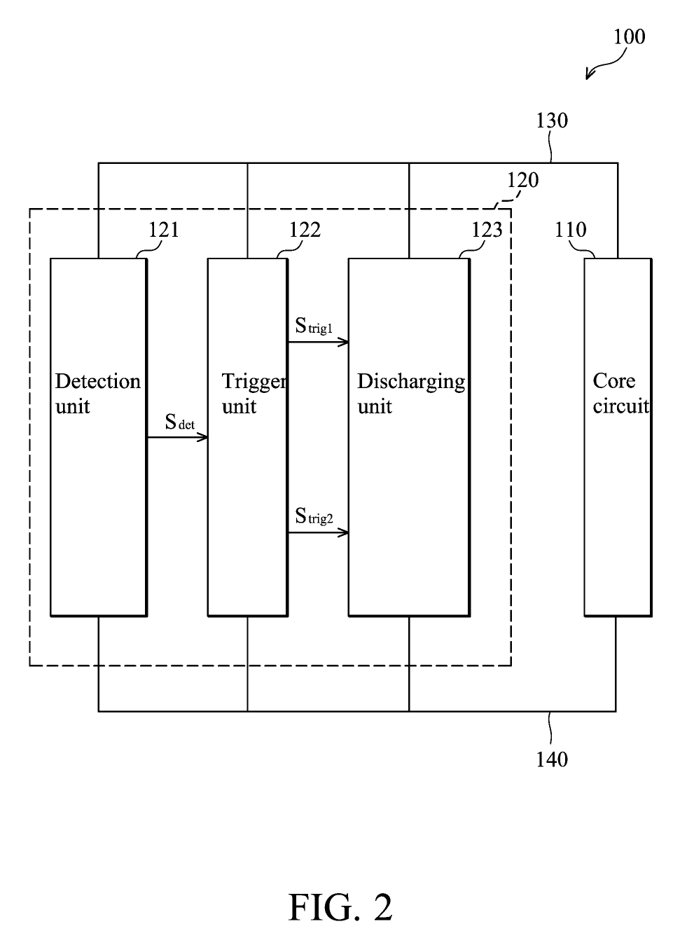

FIG. 2 is a schematic diagram of an exemplary embodiment of an integrated circuit. The integrated circuit 100 comprises a core circuit 110 and an ESD protection circuit 120. The core circuit 110 is coupled between the power lines 130 and 140. The ESD protection circuit 120 is also coupled between the power lines 130 and 140 to avoid damage to the core circuit 110 by an ESD event.

As shown in FIG. 2, the ESD protection circuit 120 comprises a detection unit 121, a trigger unit 122, and a discharging unit 123. When an ESD event occurs in the power line 130, the detection unit 121 asserts a detection signal S_{det}. After the detection signal S_{det} is asserted, the trigger unit 122 asserts the trigger signals S_{trig1} and S_{trig2}. When the trigger signals S_{trig1} and S_{trig2} are asserted, the discharging unit 123 provides a discharge path between the power lines 130 and 140 to release the ESD current caused by the ESD event.

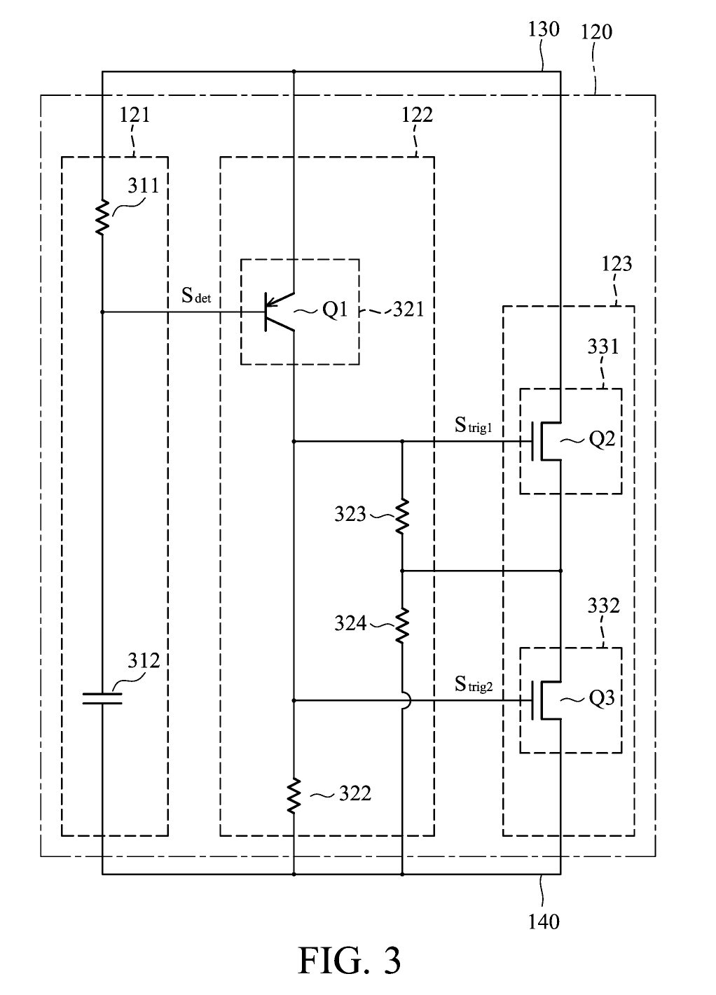

FIG. 3 is a schematic diagram of an exemplary embodiment of the ESD protection circuit. In this embodiment, the detection unit 121 comprises a resistor 311 and a capacitor 312. The resistor 311 is connected to the capacitor 312 in series between the power lines 130 and 140. The resistance of the resistor 311 and the capacitance of the capacitor 312 are utilized to control the detection signal S_{det}. For example, when an ESD event occurs in the power line 130 and the power line 140 is grounded, the detection signal S_{det} is asserted to a low level due to the resistor 311 and the capacitor 312.

Referring to FIG. 3, the trigger unit 122 comprises a trigger device 321. The trigger device 321 is coupled between the power lines 130 and 140 and generates the trigger signals S_{trig1} and S_{trig2} according to the detection signal S_{det}. The trigger signal S_{trig1} is the same as the trigger signal S_{trig2}. For example, when the detection signal S_{det} is asserted, the trigger device 321 asserts the trigger signals S_{trig1} and S_{trig2} to a high level.

As shown in FIG. 3, the trigger device 321 is a pnp bipolar junction transistor (BJT) Q1. The pnp BJT Q1 comprises a base receiving the detection signal S_{det}, a emitter coupled to the power line 130 and a collector outputting the trigger signals S_{trig1} and S_{trig2}. In this embodiment, the pnp BJT Q1 is coupled to the power line 140 via a resistor 322.

In addition, the trigger unit 122 further comprises resistors 322˜324. The resistor 322 is coupled between the collector of the pnp BJT Q1 and the power line 140. The resistor 323 is connected to the resistor 324 in series between the collector of the pnp BJT Q1 and the power line 140. In some embodiments, the resistors 322˜324 can be omitted.

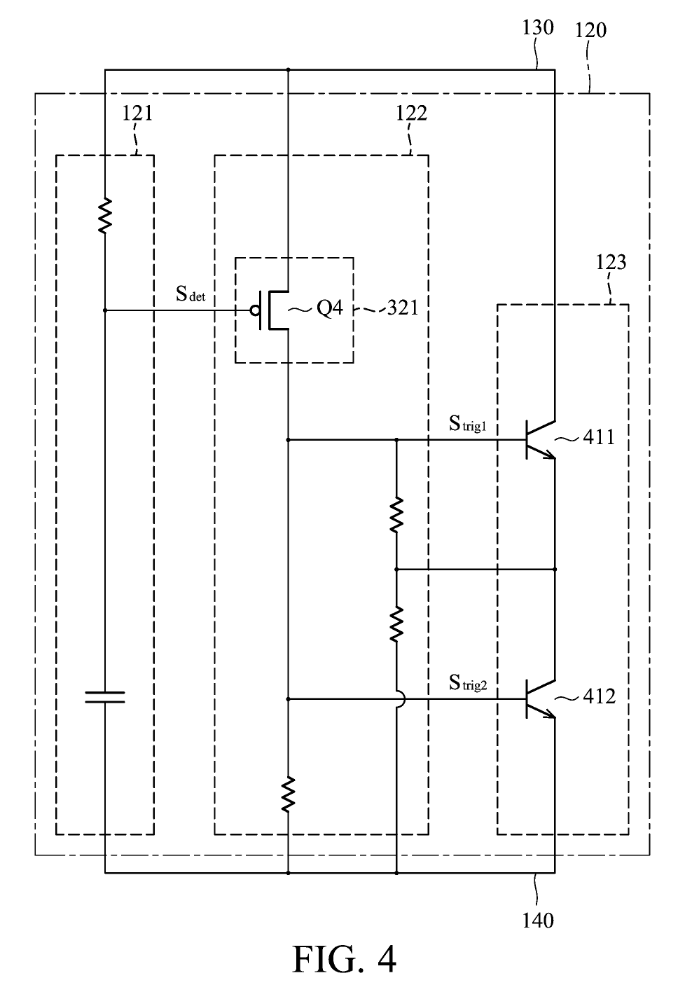

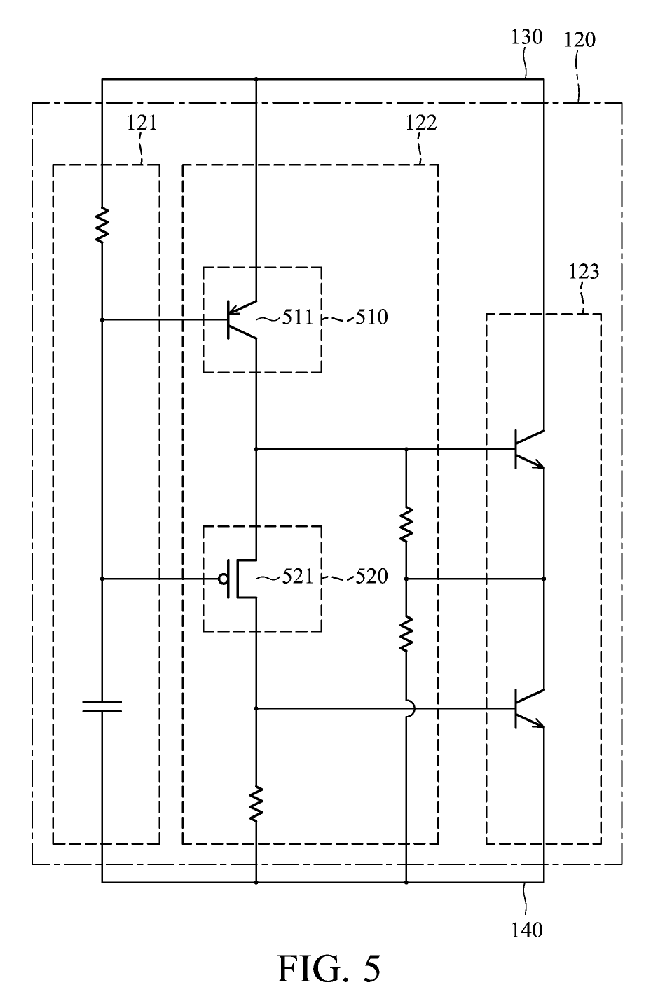

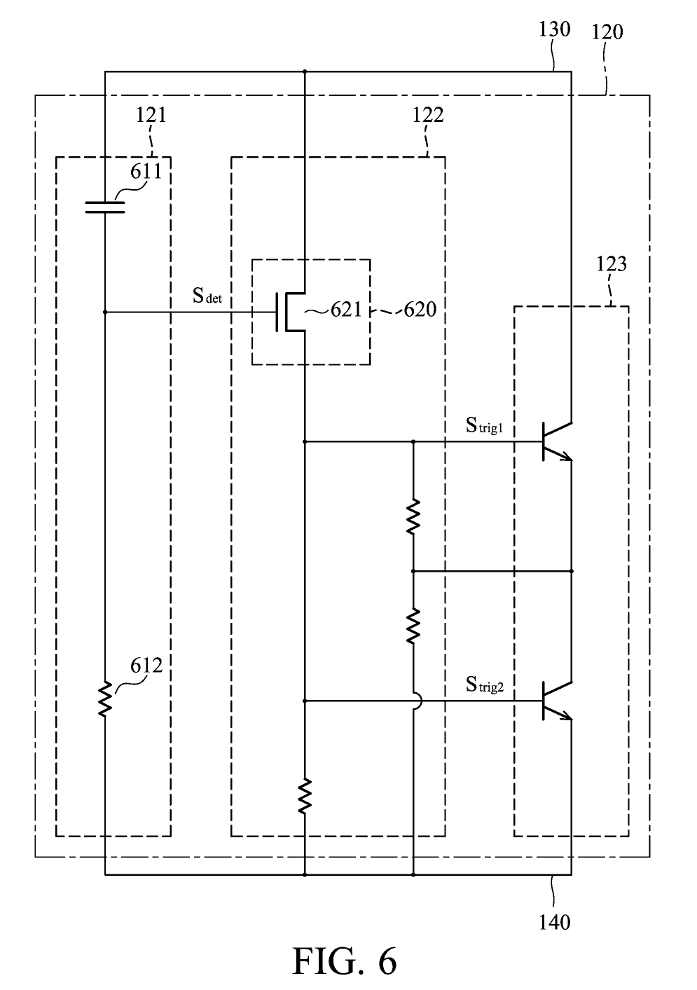

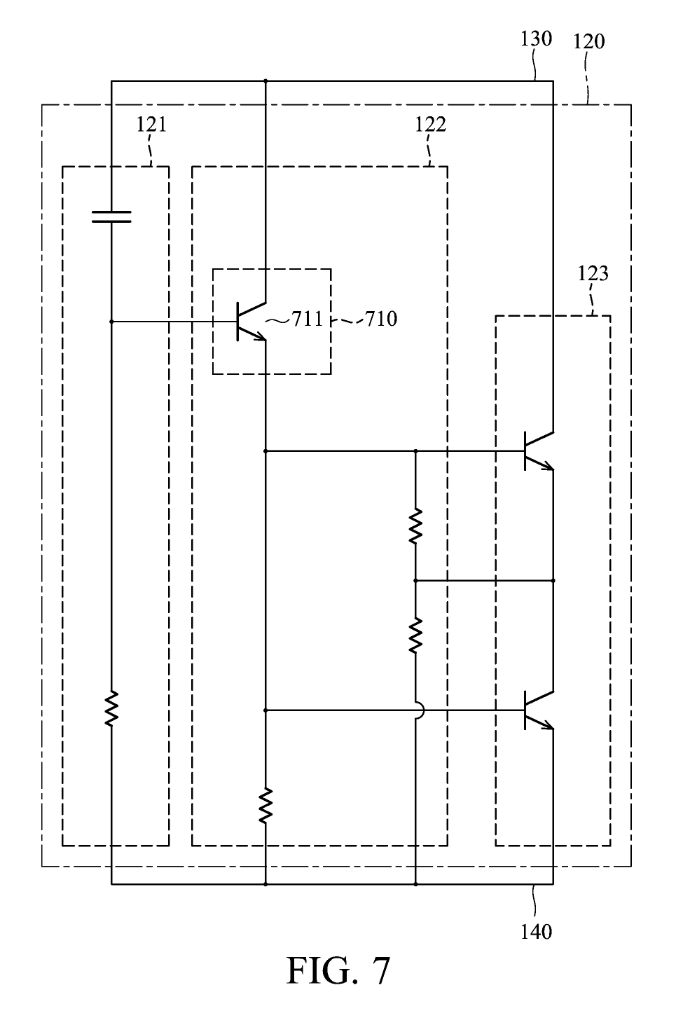

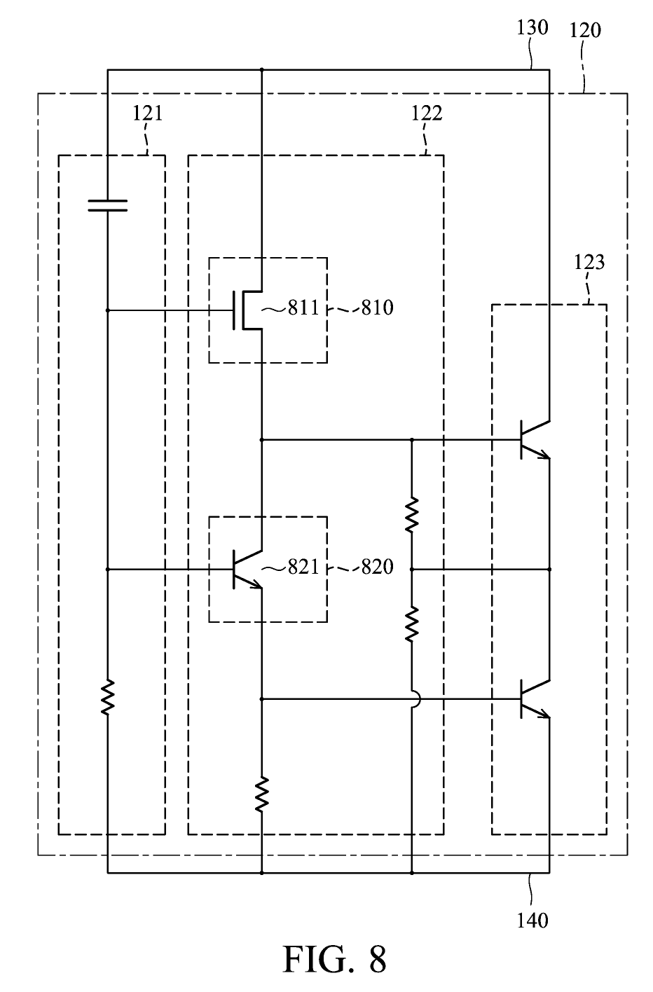

The discharging unit 123 comprises discharge devices 331 and 332. The discharge device 331 receives the trigger signal S_{trig1}. The discharge device 332 receives the trigger signal S_{trig2} and is connected to the discharge device 331 in series between the power lines 130 and 140. In this embodiment, the discharge device 331 is a NMOS transistor Q2 and the discharge device 332 is a NMOS transistor Q3. In other embodiments, the discharge devices 331 and 322 are replaced by the npn BJTs (shown in FIG. 4).

As shown in FIG. 3, the drain of the NMOS transistor Q2 is coupled to the power line 130. The gate of the NMOS transistor Q2 is coupled to the resistors 322 and 323 and the collector of the pnp BJT Q1. The drain of the NMOS transistor Q3 is coupled to the source of the NMOS transistor Q2. The gate of the NMOS transistor Q3 is coupled to the collector of the pnp BJT Q1 and the resistor 322. The source of the NMOS transistor Q3 is coupled to the power line 140.

The operating configuration of the ESD protection circuit 120 is described in greater detail with reference to FIG. 3. When an ESD event occurs in the power line 130 and the power line 140 is grounded, the detection unit 121 asserts the detection signal S_{det} such that the detection signal S_{det} is at a low level. Since the detection signal S_{det} is at the low level, the trigger unit 122 asserts the trigger signals S_{trig1} and S_{trig2}. Each of the trigger signals S_{trig1} and S_{trig2} is at a high level. Thus, the discharging unit 123 provides a discharge path between the power lines 130 and 140 to release ESD stress.

FIG. 4 is a schematic diagram of another exemplary embodiment of the ESD protection circuit. FIG. 4 is similar to FIG. 3 with the exception of the trigger device 321 and the discharging unit 123. As shown in FIG. 4, a PMOS transistor Q4 constitutes the trigger device 321 and the npn BJTs 411 and 412 constitutes the discharging unit 123. In other embodiments, the npn BJTs 411 and 412 shown in FIG. 4 can be replaced by the NMOS transistors Q2 and Q3 shown in FIG. 3. In some embodiments, the PMOS transistor Q4 shown in FIG. 4 can be replaced by the pnp BJT Q1 shown in FIG. 3. Since FIGS. 3 and 4 have the same principle, related descriptions of FIG. 4 are omitted for brevity.

FIG. 5 is a schematic diagram of another exemplary embodiment of the ESD protection circuit. FIG. 5 is similar to FIG. 4 with the exception that the trigger unit 122 comprises trigger devices 510 and 520. The trigger devices 510 and 520 are connected in series between the power lines 130 and 140. In this embodiment, the trigger device 510 is a pnp BJT 511 and the trigger device 520 is a PMOS transistor 521. Since FIGS. 3 and 5 have the same principle, related descriptions of FIG. 5 are omitted for brevity.

FIG. 6 is a schematic diagram of another exemplary embodiment of the ESD protection circuit. FIG. 6 is similar to FIG. 3 with the exception of the detection unit 121 and the trigger unit 122. The trigger unit 122 comprises a trigger device 620 constituted by an NMOS transistor 621. The detection unit 121 comprises a capacitor 611 and a resistor 612. The capacitor 611 is coupled between the drain and the gate of the NMOS transistor 621. The resistor 612 is coupled between the gate of the NMOS transistor 621 and the power line 140. In this embodiment, when an ESD event occurs in the power line 130 and the power line 140 is grounded, the detection signal S_{det} is asserted to a high level. When the detection signal S_{det} is at the high level, the NMOS transistor 621 asserts the trigger signals S_{trig1} and S_{trig2} such that the trigger signals S_{trig1} and S_{trig2} are at a high level.

FIG. 7 is a schematic diagram of another exemplary embodiment of the ESD protection circuit. FIG. 7 is similar to FIG. 6 with the exception of the trigger unit 122. As shown in FIG. 7, the trigger unit 122 comprises a trigger device 710. The trigger device 710 is constituted by an npn BJT 711. Since FIGS. 6 and 7 have the same principle, related descriptions of FIG. 7 are omitted for brevity.

FIG. 8 is a schematic diagram of another exemplary embodiment of the ESD protection circuit. FIG. 8 is similar to FIG. 6 with the exception that the trigger unit 122 comprises trigger devices 810 and 820. In this embodiment, the trigger device 810 is constituted by an NMOS transistor 811 and the trigger device 820 is constituted by an npn BJT 821. The NMOS transistor 811 is connected to the npn BJT 821 in series between the power lines 130 and 140. Since FIGS. 6 and 8 have the same principle, related descriptions of FIG. 8 are omitted for brevity

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrostatic discharge (ESD) protection circuit, coupled between a first power line and a second power line to avoid damage to an integrated circuit by an ESD event, comprising:
a detection unit asserting a detection signal when the ESD event occurs;
a trigger unit asserting a first trigger signal and a second trigger signal when the detection is asserted; and
a discharging unit providing a discharge path to release an ESD current caused by the ESD event when the first and the second trigger signals are asserted.

2. The ESD protection circuit as claimed in claim 1, wherein the discharging unit comprises:
a first discharge device receiving the first trigger signal; and
a second discharge device receiving the second trigger signal and connecting with the first discharge device in series between the first and the second power lines.

3. The ESD protection circuit as claimed in claim 2, wherein each of the first and the second discharge devices is an npn BJT or an NMOS transistor.

4. The ESD protection circuit as claimed in claim 1, wherein the trigger unit comprises a first trigger device coupled between the first and the second power lines and generating the first and the second trigger signals according to the detection signal, wherein the first trigger signal is the same as the second trigger signal.

5. The ESD protection circuit as claimed in claim 4, wherein the first trigger device is a PMOS transistor, an NMOS transistor, a pnp BJT, or an npn BJT.

6. The ESD protection circuit as claimed in claim 2, wherein the trigger unit comprises:
a first trigger device generating the first trigger signal according to the detection signal; and
a second trigger device connecting with the first trigger device in series between the first and the second power lines and generating the second trigger signal according to the detection signal.

7. The ESD protection circuit as claimed in claim 6, wherein the first trigger device is a pnp BJT and the second trigger device is a PMOS transistor.

8. The ESD protection circuit as claimed in claim 6, wherein the first trigger device is an NMOS transistor and the second trigger device is an npn BJT.

9. The ESD protection circuit as claimed in claim 6, wherein the trigger unit comprises:
a first resistor coupled between the second trigger device and the second power line;
a second resistor; and
a third resistor connecting with the second resistor in series between the first discharge device and the second power line.

10. The ESD protection circuit as claimed in claim 1, wherein the detection unit comprises:
a resistor coupled between the first power line and the trigger unit; and
a capacitor coupled between the trigger unit and the second power line.

11. The ESD protection circuit as claimed in claim 1, wherein the detection unit comprises:
a resistor coupled between the second power line and the trigger unit; and
a capacitor coupled between the trigger unit and the first power line.

12. An integrated circuit, comprising:
a core circuit coupled between a first power line and a second power line; and
an electrostatic discharge (ESD) protection circuit coupled between the first and the second power lines to avoid damage to the core circuit by an ESD event, comprising:
a detection unit asserting a detection signal when the ESD event occurs;
a trigger unit asserting a first trigger signal and a second trigger signal when the detection is asserted; and
a discharging unit providing a discharge path to release an ESD current caused by the ESD event when the first and the second trigger signals are asserted.

13. The integrated circuit as claimed in claim 12, wherein the discharging unit comprises:
a first discharge device receiving the first trigger signal; and
a second discharge device receiving the second trigger signal and connecting with the first discharge device in series between the first and the second power lines.

14. The integrated circuit as claimed in claim 13, wherein each of the first and the second discharge devices is an npn BJT or an NMOS transistor.

15. The integrated circuit as claimed in claim 12, wherein the trigger unit comprises a first trigger device coupled between the first and the second power lines and generating the first and the second trigger signals according to the detection signal, wherein the first trigger signal is the same as the second trigger signal.

16. The integrated circuit as claimed in claim 15, wherein the first trigger device is a PMOS transistor, an NMOS transistor, a pnp BJT, or an npn BJT.

17. The integrated circuit as claimed in claim 13, wherein the trigger unit comprises:
a first trigger device generating the first trigger signal according to the detection signal; and
a second trigger device connecting with the first trigger device in series between the first and the second power lines and generating the second trigger signal according to the detection signal.

18. The integrated circuit as claimed in claim 17, wherein the first trigger device is a pnp BJT and the second trigger device is a PMOS transistor.

19. The integrated circuit as claimed in claim 17, wherein the first trigger device is an NMOS transistor and the second trigger device is an npn BJT.

20. The integrated circuit as claimed in claim 17, wherein the trigger unit comprises:
a first resistor coupled between the second trigger device and the second power line;
a second resistor; and
a third resistor connecting with the second resistor in series between the first discharge device and the second power line.

21. The integrated circuit as claimed in claim 12, wherein the detection unit comprises:
a resistor coupled between the first power line and the trigger unit; and
a capacitor coupled between the trigger unit and the second power line.

22. The integrated circuit as claimed in claim 12, wherein the detection unit comprises:
a resistor coupled between the second power line and the trigger unit; and
a capacitor coupled between the trigger unit and the first power line.
